(19) United States
(12) Patent Application Publication
(10) Pub. No.: US 2024/0191702 A1
(43) Pub. Date: Jun. 13, 2024

(54) CAPACITY CONFIGURATION METHOD FOR PHOTOVOLTAIC/PHOTOTHERMAL/AA-CAES OF COMBINED COOLING, HEATING AND POWER

(71) Applicant: HANGZHOU DIANZI UNIVERSITY, Hangzhou City (CN)

(72) Inventors: Chenxi WU, Hangzhou City (CN); Suoyin NI, Hangzhou City (CN); Hanxiao HONG, Hangzhou City (CN); Jianxiong YE, Hangzhou City (CN)

(73) Assignee: HANGZHOU DIANZI UNIVERSITY, Hangzhou City (CN)

(21) Appl. No.: 18/512,874

(22) Filed: Nov. 17, 2023

(30) Foreign Application Priority Data
Nov. 25, 2022 (CN) 202211492796.8

(51) Int. Cl. F03G 6/00; F03G 6/06

(52) U.S. Cl. CPC F03G 6/001; F03G 6/002; F03G 6/06; F03G 6/071

(57) ABSTRACT

A capacity configuration method for photovoltaic/photothermal/Advanced Adiabatic Compressed Air Energy Storage (AA-CAES) of combined cooling, heating and power (CCHP). The method includes: establishing a CCHP micro integrated energy system model containing AA-CAES, and then solving the model by using a dual-level planning approach. The upper level plans capacity configuration is planned with an objective of minimizing a sum of capacity configuration costs and lower-level scheduling costs, while the lower level employs parameters obtained from the upper level to implement season-based scheduling, with an objective of minimizing a sum of energy supply costs and carbon mitigation costs, and returns a scheduling result to the upper level to assist in upper-level capacity decisions. This method takes a CCHP capability of a compressed air energy storage system into consideration, and establishes a model suitable for capacity planning and scheduling.

### CROSS REFERENCE TO RELATED APPLICATION

This application claims foreign priority benefits under 35 U.S.C. §119(a)-(d) to Chinese Patent Application No. 202211492796.8 filed on Nov. 25, 2022, which is hereby incorporated herein by reference in its entirety.

### TECHNICAL FIELD

The present disclosure relates to the technical field of power systems, and in particular, to a capacity configuration method for photovoltaic/photothermal/Advanced Adiabatic Compressed Air Energy Storage (AA-CAES) of combined cooling, heating and power (CCHP).

### BACKGROUND

With the growing level of global economic production and consumption, the issues of non-renewable energy scarcity and environmental pollution have become increasingly severe. The development and utilization of renewable resources have become key solutions to these problems. Combined Cooling, Heating and Power (CCHP) with new energy is considered as an effective approach to address the environmental issues and energy shortages, as well as an important topic for achieving energy internetization. Adding energy storage devices to a micro integrated energy system can enhance the renewable energy absorption capability and operational flexibility of the system^{[1]}. Therefore, it is crucial to configure the capacity of the energy storage system rationally.

Among numerous energy storage technologies, Advanced Adiabatic Compressed Air Energy Storage (AA-CAES) technology stands out due to its advantages such as low capacity costs, long operational lifespan, and large capacity. Additionally, AA-CAES has the ability to provide combined cooling, heating, and power, which makes it well-suited to the multi-energy coupling characteristics of micro integrated energy systems, achieving a comprehensive energy utilization rate of over 70%^{[2]}. In recent years, China has established several small-scale compressed air energy storage demonstration platforms, which have promoted the application of compressed air energy storage technology^{[3]}.

Currently, scholars are conducting research on AA-CAES. Reference [3] established a combined power generation model of AA-CAES with wind power and assessed the generation costs and supply reliability. Reference [4] established a model by introducing AA-CAES into a microgrid, with the goal of minimizing exergy, and studied the scheduling strategy of the system. However, neither of the references has taken the capacity configuration of AA-CAES into consideration. Reference [5], aimed at absorbing wind power, established island-based CAES power plants and proposed a capacity optimization method. Reference [6] considered integrating AA-CAES into an integrated energy system for combined heat and power supply, thus planning the capacity. The mentioned references have discussed CAES capacity configuration to some extent but did not consider the CCHP scenario or impact of initial storage ratios of the thermal storage chamber and the air storage chamber on the system.

[1] Jiang Haiyang, Du Ershun, Zhu Guiping, et al. Review and Prospect of Seasonal Energy Storage for Power System with High Proportion of Renewable Energy[J]. Power System Automation, 2020, 44(19): 194-207.

[2] Mei Shengwei, Li Rui, Chen Laijun, et al. An Overview and Outlook on Advanced Adiabatic Compressed Air Energy Storage Technique[J]. Proceedings of the Chinese Society for Electrical Engineering. 2018, 38(10): 2893-2907.

[3] Wu Chenxi, Chen Zehao, Zhang Jie, et al. Cost/Power Supply Reliability Assessment Of Wind Power Generation System Considering Advanced Adiabatic Compressed Air Energy Storage[J]. Electric Power Automation Equipment, 2020, 40(2): 62-71.

[4] Wu Chenxi, He Zhanglu, Ye Jianxiong, Hong Hanxiao. Energy-saving Scheduling of Multi-energy Flow Based on Exergy Evaluation. Electric Power Science and Engineering, 2021, 37(8): 41-50.

[5] ZAFIRAKIS D, KALDELLIS J K. Autonomous Dual-mode CAES Systems for Maximum Wind Energy Contribution in Remote Island Networks[J]. Energy Conversion and Management, 2010, 51(11): 2150-2161.

[6] Ning Guangtao, Li Linwei, He Lipeng, Chen Mingfan, Zheng Zhu. Capacity Planning Method of Energy Storage System For Micro Integrated Energy System in Environmental Friendly Islands[J]. Electric Power Automation Equipment, 2021, 41(02): 8-15.

### SUMMARY

To address the shortcomings in the prior art, the present disclosure provides a capacity configuration method for photovoltaic/photothermal/AA-CAES of CCHP, which uses a dual-level optimization approach to plan the capacity of relevant component equipment in an AA-CAES energy storage system.

The capacity configuration method for photovoltaic/photothermal/AA-CAES of CCHP specifically includes the following steps:

Step 1: Establish a CCHP micro integrated energy system model containing AA-CAES, which includes inputs from renewable energy sources of wind power, photovoltaic power, and solar thermal collection, a combined heat and power (CHP) unit with a gas generator and a waste heat recovery boiler, refrigeration equipment for absorption cooling and electric cooling, and an energy storage device of AA-CAES. In this system model, it is assumed that air behaves as an ideal gas, following an ideal gas state equation; an air storage chamber has a temperature approximately equal to ambient temperature, and a thermal storage chamber has a temperature approximately equal to a rated temperature; a heat transfer medium is water.

Step 2: Establish an upper-level objective function max B_{bf}, with an objective of maximizing a net benefit brought by AA-CAES:

max B_{bf}=C_{noCAES}−C_{CAES}−C_{TCC}−C_{O&M} (1)

where C_{noCAES} is energy costs without AA-CAES configuration; C_{CAES} is energy costs with AA-CAES configuration, derived from lower-level scheduling; C_{TCC} is annualized investment costs; and C_{O&M} is annualized operation and maintenance costs of the system.

Upper-level decision variables x include:

x={A_{PV},A_{SF},P_{CAESc},P_{CAESt},Vᵥ,Vₕ,ωᵥ,ωₕ} (2)

where A_{PV} is the number of photovoltaic panels; A_{SF} is a ground area of a mirror field; P_{CAESc} is a rated power of a compressor; P_{CAESt} is an expansion power of an expander; Vᵥ is a volume of the air storage chamber; Vₕ is a volume of the thermal storage chamber; ωᵥ is an initial gas proportion in the air storage chamber; and on is an initial hot water proportion in the thermal storage chamber.

Upper-level constraints are ground areas for photovoltaic panels and solar thermal collection:

A_{PV}S_{PV}+A_{SF}≤S_{MAX} (3)

where S_{PV} is a ground area for a single photovoltaic panel; and S_{MAX} is a maximum total ground area.

Step 3: Establish a lower-level objective function, with a scheduling objective of minimizing energy supply costs and carbon mitigation costs after configuring AA-CAES:

$${C}_{CAES} = {D}_{spa} ( {P}_{spa} {C}_{e} + {P}_{spaGT} τ {C}_{gas} + {P}_{spab} {ψ}_{e} {C}_{{co}_{2}} + {P}_{spaGT} {τψ}_{e} {C}_{{co}_{2}} ) + {D}_{su} ( {P}_{sub} {C}_{e} + {P}_{suGT} τ {C}_{gas} + {P}_{sub} {ψ}_{e} {C}_{{co}_{2}} + {P}_{suGT} {τψ}_{g} {C}_{{co}_{2}} ) + {D}_{w} ( {P}_{wb} {C}_{e} + {P}_{wGT} {τC}_{gas} + {P}_{wb} {ψ}_{e} {C}_{{co}_{2}} + {P}_{wGT} {τψ}_{g} {C}_{{co}_{2}} ) \qquad ( 4 )$$

where Dₛₚₐ, Dₛᵤ, D_{w} represent the number of days in transitional seasons, summer, and winter, respectively, during one year; P_{spab}, P_{sub}, P_{wb} represent amounts of purchased electricity on typical days in transitional seasons, summer, and winter, respectively; Cₑ is an electricity price, using time-of-use pricing; P_{spaGT}, P_{suGT}, P_{wGT} represent outputs of a gas turbine on typical days in transitional season, summer, and winter, respectively; τ is a correlation coefficient between the output of the gas turbine and natural gas; C_{gas} is purchase costs of natural gas per unit; ψₑ is a conversion coefficient of CO₂ per unit of grid electricity; ψₑ is a conversion coefficient of CO₂ per unit of natural gas combustion; and C_{co}_{₂} is mitigation costs per unit of CO₂.

Lower-level decision variables x include:

x={P_{CAESc,t},P_{CAESg,t},P_{GT,t},P_{b,t},P_{cold,t},P_{rb,t},M_{tesc,t},M_{tesx,t},M_{tescold,t}} (5)

where P_{CAESc,t} is an output of the compressor at time t; P_{CAESg,t} is an output of the expander at time t; P_{GT,t} is an output of the gas turbine at time t; P_{b,t} is an amount of electricity purchased from a power grid at time t; P_{rb,t} is an amount of electricity consumed by a heat pump at time t; P_{cold,t} is an amount of electricity used for cooling at time t; M_{tesc,t} is a mass of hot water stored into the thermal storage chamber at time t; M_{tesx,t} is a mass of hot water supplied from the thermal storage chamber at time t; and M_{tescold,t} is a mass of hot water used for absorption cooling at time t.

Lower-level constraints include:

### (1) Electrical Power Balance Constraint:

P_{b,t}+P_{GT,t}+P_{WT,t}+P_{PV,t}+P_{t,t}=P_{L,t}+P_{c,t}+P_{bc,t} (6)

where P_{WT,t} is a wind power output at time t; P_{bc,t} is an amount of electricity used for electric cooling; and P_{L,t} is an amount of electricity for electric load.

### (2) Thermal Power Balance Constraint:

H_{gl,t}+M_{tesg,t}σₕ+P_{SF,t}+M_{c,2}σₕ+P_{rb}σₑᵣ=H_{L,t}+M_{tesc,t}σₕ+M_{g,2}σₕ+M_{tescold,t}σₕ (7)

where H_{L,t} is thermal load at time t; M_{c,2} and M_{g,2} represent a mass of water for compression/expansion and a mass of water for heat generation, respectively; and σₕ is a conversion coefficient between a hot water mass and heat.

### (3) Cold Power Balance Constraint:

P_{bc,t}σ_{ec}+M_{tescold,t}σₕσ_{hc}+P_{t,cold,t}=Cold_{L,t} (8)

where σ_{ec} is electric cooling efficiency; σ_{hc} is absorption cooling efficiency; P_{t,cold,t} is a cooling capacity of the expander at time t; and Cold_{L,t} is cooling load at time t. (4) AA-CAES module constraints:

$$\{ \begin{matrix}0 \leq {u}_{c , t} + {u}_{t , t} \leq 1 \\ 0 \leq {P}_{c , t} \leq {u}_{c , t} {P}_{CAESc} \\ 0 \leq {P}_{t , t} \leq {u}_{t , t} {P}_{CAESt} \\ {V}_{v} {ρ}_{min} \leq {M}_{a , c} {u}_{c , t} - {M}_{a , t} {u}_{t , t} + {M}_{air , t} \leq {V}_{v} {ρ}_{max}\end{matrix} \qquad ( 9 )$$

where the first equation represents condition constraints for a compression turbine, and u_{c,t} and u_{g,t} represent conditions of the compression turbine at time t, which are binary variables; the second equation represents constraints on a compression power; the third equation represents constraints on an expansion power; and the fourth equation represents constraints on the air storage chamber, where M_{a,c} and M_{a,t} represent air masses during compression/expansion, and ρₘᵢₙ/ρₘₐₓ represent an air density corresponding to a minimum/maximum pressure set for the air storage chamber.

### (5) CHP Constraints:

$$\{ \begin{matrix}{μ}_{GT , t} {P}_{GT , min} \leq {P}_{GT , t} \leq {μ}_{GT , t} {P}_{GT , max} \\ 0 \leq {H}_{gl , t} \leq {H}_{gl , max}\end{matrix} \qquad ( 10 )$$

where the first equation represents an output constraint on the gas turbine, μ_{GT,t} is a start-stop coefficient of the gas turbine and is a binary variable, and P_{GT,max} and P_{GT,min} represent a maximum output value and a minimum output value of the gas turbine; and the second equation represents an output constraint on the waste heat recovery boiler, where H_{gl,max} is a maximum output value of the waste heat recovery boiler.

### (6) Thermal Storage Chamber Constraints:

$$\{ \begin{matrix}0 \leq {μ}_{hc , t} + {μ}_{hx , t} \leq 0 \\ {V}_{min} {ρ}_{w} \leq {M}_{tesc , t} {μ}_{hc , t} - {M}_{tesx , t} {μ}_{hx , t} + {M}_{tes , t} \leq {V}_{h} {ρ}_{w}\end{matrix} \qquad ( 11 )$$

where in the first equation, μ_{hc,t} and μ_{hx,t} represent condition constraints for thermal storage/supply of the thermal storage chamber; and in the second equation, Vₘᵢₙ is a minimum thermal storage value set for the thermal storage chamber, ρ_{w} is a density at a set temperature of the thermal storage chamber, and M_{tes,t} is a mass of stored hot water in the thermal storage chamber at time t.

### (7) Heat Pump and Electric Cooling Constraints:

$$\{ \begin{matrix}0 \leq {P}_{rb} * {σ}_{er} \leq {Q}_{rb} \\ 0 \leq {P}_{bc} * {σ}_{ec} \leq {Cold}_{bc}\end{matrix} \qquad ( 12 )$$

where Q_{rb} is a maximum output thermal power of the heat pump, and Cold_{bc} is a maximum output power for electric cooling.

### (8) Electricity Purchase Constraints:

−P_{s,max}≤P_{b,t}≤P_{b,max} (13)

where P_{b,max} represents a maximum amount of purchased electricity, and P_{s,max} represents a maximum amount of sold electricity.

Step 4: Perform crossover and mutation on decision variables by using a genetic algorithm (NSGA-II) at the upper level, with an objective of minimizing total costs, select new parent capacity values based on the total costs by applying an elite retention strategy, and pass down results to the lower level. At the lower level, a Gurobi solver is employed to schedule a lower-level model after the results from the upper level are received; and scheduling results are then returned to the upper level to assist in capacity decisions, achieving dual-level planning.

The present disclosure has the following beneficial effects:

This method takes a CCHP capability of a compressed air energy storage system into consideration, and establishes a model suitable for capacity planning and scheduling. Lower-level scheduling takes into account the operational characteristics of typical days in different seasons, with an objective of optimizing the carbon mitigation costs. Upper-level planning takes into account the selection of initial capacity values for the air storage chamber and thermal storage chamber, comprehensively optimizing the compression/expansion power and the air/thermal storage capacity.

### BRIEF DESCRIPTION OF THE DRAWINGS

FIG. 1 is an energy flow diagram of a CCHP micro integrated energy system;

FIGS. 2A-B are structural diagrams of AA-CAES;

FIG. 3 is CCHP load in winter according to an embodiment;

FIG. 4 is CCHP load in transitional seasons according to an embodiment;

FIG. 5 is CCHP load in summer according to an embodiment;

FIG. 6 is a sunlight intensity curve according to an embodiment;

FIG. 7 shows wind power output of each season according to an embodiment;

FIG. 8 is a flowchart of a dual-level planning algorithm;

FIG. 9 shows a result of electricity scheduling in winter according to an embodiment;

FIG. 10 shows a result of electricity scheduling in summer according to an embodiment;

FIG. 11 shows a result of electricity scheduling in transitional seasons according to an embodiment;

FIG. 12 shows a result of heat scheduling in winter according to an embodiment;

FIG. 13 shows a result of heat scheduling in summer according to an embodiment;

FIG. 14 shows a result of heat scheduling in transitional seasons according to an embodiment;

FIG. 15 shows a result of cooling scheduling in winter according to an embodiment;

FIG. 16 shows a result of cooling scheduling in summer according to an embodiment;

FIG. 17 shows a result of cooling scheduling in transitional seasons according to an embodiment;

FIG. 18 shows a thermal water storage status in a thermal storage chamber according to an embodiment; and

FIG. 19 shows an air storage status in an air storage chamber according to an embodiment.

### DETAILED DESCRIPTION

The present disclosure will be further illustrated below with reference to the accompanying drawings.

The capacity configuration method for photovoltaic/photothermal/AA-CAES of CCHP specifically includes the following steps:

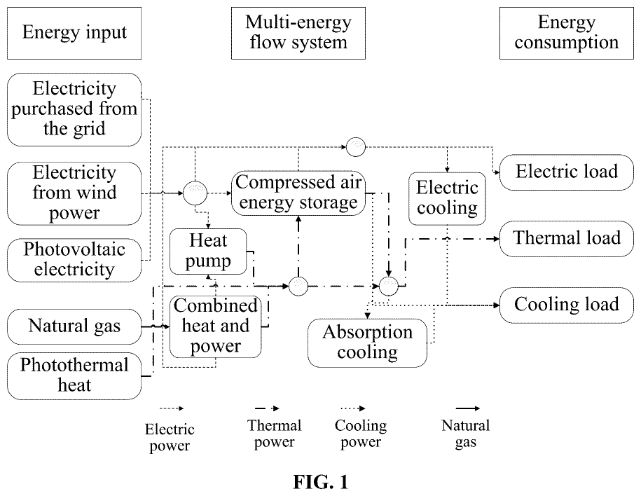

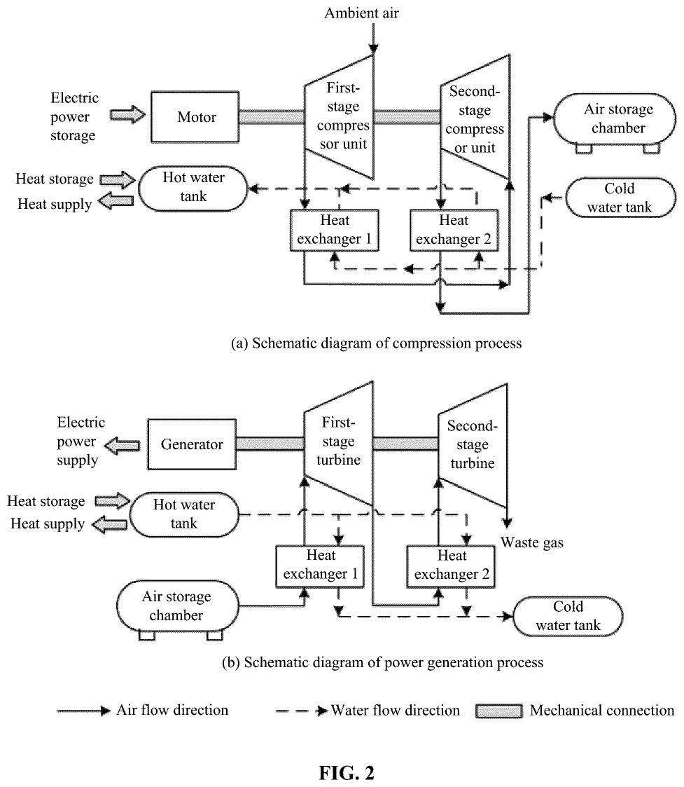

Step 1: Assuming that air behaves as an ideal gas, following an ideal gas state equation, an air storage chamber has a temperature approximately equal to ambient temperature, and a thermal storage chamber has a temperature approximately equal to a rated temperature, establish a CCHP micro integrated energy system model containing AA-CAES, with water as a heat transfer medium, where a system structure and energy flow chart are as shown in FIG. 1, including a compressor, an expander, a motor, a generator, a thermal storage chamber, an air storage chamber, and a heat exchanger. The AA-CAES model includes a compression phase, a compression heat transfer phase, a compression heat storage phase, an expansion heat transfer phase, an expansion heat release phase, and an expansion phase, with a typical 2-stage compression and 2-stage expansion structure as shown in FIGS. 2A-B. In this embodiment, 4-stage compression and 4-stage expansion are selected, and system parameters are shown in Table 1:

TABLE 1

| Parameter | Value |
|---|---|
| Ambient temperature T/K | 293 |
| Ambient pressure P0/(pa) | 100000 |
| Compression ratio per stage π_{c} | 3.16 |
| Expansion ratio per stage πₜ | 3.16 |
| Heat exchanger efficiency ε | 0.8 |
| Isentropic efficiency of the compressor η_{c} | 0.75 |
| Isentropic efficiency of the expander ηₜ | 0.8 |
| Specific heat capacity of gas cₚ (J/(kg · K)) | 1 |
| Specific heat capacity of water c_{w} (J/(kg · K)) | 4200 |
| Mass of heat transfer medium water m_{w} (kg) | 10 |
| Specific heat capacity of air γ | 1.4 |
| Upper pressure limit of air storage chamber/bar | 100 |
| Lower pressure limit of air storage chamber/bar | 60 |

An output power of the i-th stage expander in the expansion phase is:

P_{t,i}(t)=ηₜmₐcₚTᵢ[1−βₜ^{-(γ-1)/(γN)}] (14)

where ηₜ is expansion efficiency, and βₜ is an expansion ratio of the expander. A corresponding air mass can be derived from the expansion power.

An air outlet temperature of the i-th stage expander in the expansion phase is:

T_{t,i,out}=Tᵢ{1−ηₜ[1−βₜ^{-(γ-1)/(γN)}]} (15)

A cooling capacity output of the expansion phase is:

P_{t,cold}=mₐcₚ(T₀−T_{t,N,out}) (16)

where T₀ is the ambient temperature, and T_{t,N,out} is an outlet temperature of the last-stage expander.

A photovoltaic output power model is:

Pₚᵥ=P_{STC}I[1+k(Tₚᵥ−Tᵣ)]/I_{STC}A_{PV} (17)

where P_{STC} is a rated power of the photovoltaic panel under standard test conditions (I_{STC} is 1000 w/m², and Tᵣ is 25° C.); I is light intensity; k is a power temperature coefficient; A_{PV} is the number of photovoltaic panels; and Tₚᵥ is a temperature of a photovoltaic power generation component:

Tₚᵥ=T₀+0.03I (18)

A linear Fresnel concentrating heat collection module is selected as a solar concentrating heat collection subsystem in the system, with a model expression as follows:

P_{SF}=IA_{SF}I_{L}I_{T}η_{OPT,R}η_{END}η_{CIN} [symbol] (19)

where A_{SF} is a ground area of a mirror field; I_{L} and I_{T} are longitudinal and transverse components of an incidence angle adjustment rate; η_{OPT,R} is reference optical efficiency; η_{END} is terminal loss optical efficiency; η_{CIN} is a cleanliness coefficient of a mirror and a glass tube; and [symbol] is a heat transfer coefficient of a solar cooling heat exchanger. The chosen numerical values for these parameters in this embodiment are shown in Table 2:

TABLE 2

| Parameter | Value |
|---|---|
| Reference optical efficiency | 0.67 |
| Cleanliness coefficient of mirror and glass tube | 0.98 |
| Heat transfer coefficient of solar cooling heat exchanger | 0.7 |
| Length of individual concentrating heat collection reflector/m | 180 |
| Focal length of individual concentrating heat collection | 16.56 |
| reflector/m | |

CHP generation includes the gas turbine unit and the waste heat recovery boiler. A relationship between the output of the gas turbine and the recovered heat is as follows:

P_{CHP}^{e}(t)=η_{CHP}^{e}G_{CHP}(t)LHV_{gas}/3.6 (20)

P_{CHP}^{h}(t)=η_{CHP}^{h}G_{CHP}(t)LHV_{gas}/3.6 (21)

where η_{CHP}^{e} and η_{CHP}^{h} are electricity generation efficiency and heat generation efficiency of the unit; P_{CHP}^{e} and P_{CHP}^{h} are electric and thermal outputs of the unit, in kW; G_{CHP} is gas consumption at time t of the CHP unit, in kg/h; LHV_{gas} is a lower heating value of natural gas. The chosen numerical values for these parameters in this embodiment are shown in Table 3:

TABLE 3

| Equipment | Parameter | Value |
|---|---|---|
| Gas turbine | Output upper limit/(kW) | 430 |
| | Output lower limit/(kW) | 100 |
| | LHV_{gas} (MJ/kg) | 50 |
| Heat pump | Heating efficiency | 0.8 |
| | Heating upper limit (kW) | 800 |
| Electric refrigerator | Cooling efficiency | 0.8 |
| | Cooling upper limit (kW) | 800 |

Unit construction costs for each piece of equipment are shown in Table 4:

TABLE 4

| Parameter | Value |
|---|---|
| Investment costs per unit of compression power/(CNY · kW⁻¹) | 2340 |
| Investment costs per unit of electric power/(CNY · kW⁻¹) | 1950 |
| Investment costs per unit volume of air storage chamber/ | 180 |
| (CNY · m⁻³) | |
| Investment costs per unit volume of hot water tank/(CNY · m⁻³) | 800 |
| Operation and maintenance costs per unit power/(CNY · kW⁻¹) | 66 |
| Investment costs per unit area of mirror field/($ · m⁻²) | 130 |

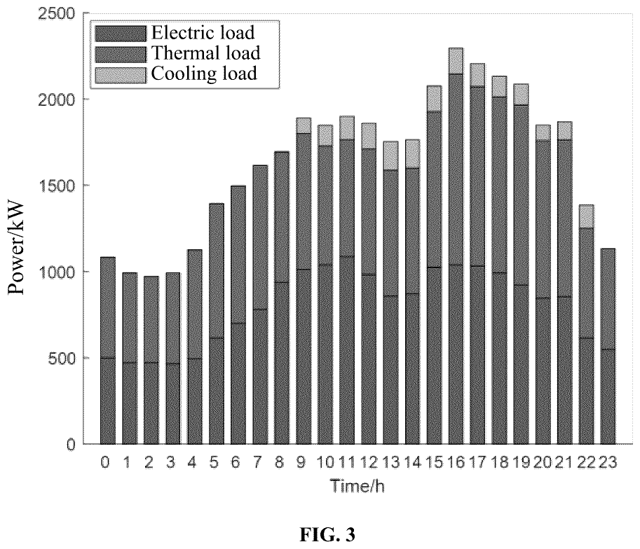

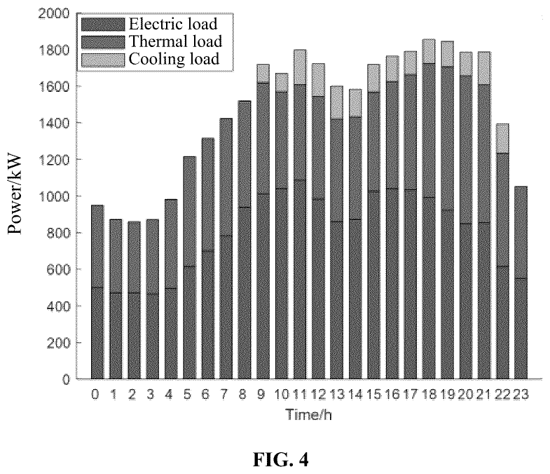

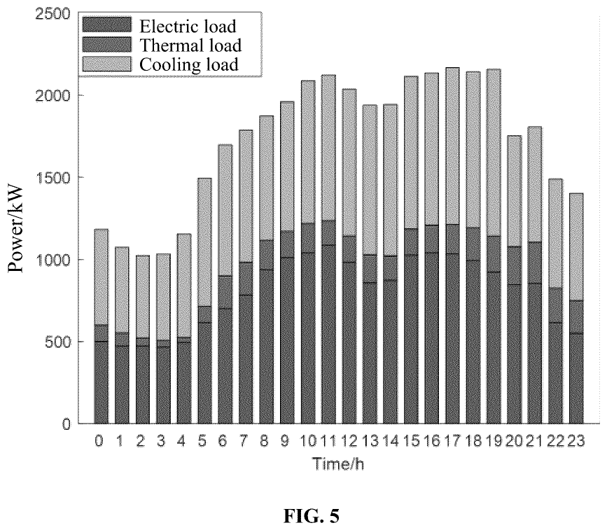

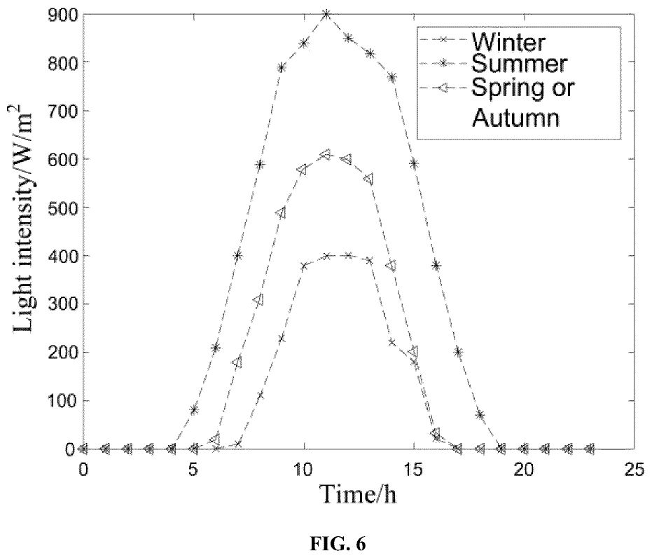

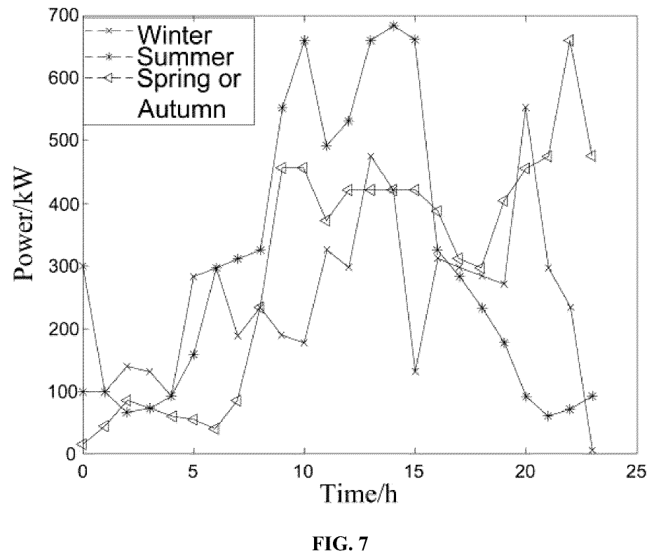

The load, wind power output, and solar radiation intensity curves for each season are shown in FIG. 3 to FIG. 7.

Step 2: Solve the model by using a dual-level planning approach, where the upper level plans capacity configuration with an objective of minimizing a sum of capacity configuration costs and lower-level scheduling costs, while the lower level is responsible for season-based categorized scheduling due to significant differences in cooling, heating, and power load across seasons. The lower level employs the capacity parameters obtained from the upper level for scheduling, with an objective of minimizing a sum of energy supply costs and carbon mitigation costs, and returns a scheduling result to the upper level to assist in capacity decisions. In this embodiment, a typical day consists of 24 hours, with a scheduling step of 1 hour. It is assumed that the operational lifespan of the system is 20 years, and the discount rate of the system is 8%. Peak-valley electricity prices are set, with peak hours (10:00-12:00 and 16:00-22:00) having a buying price of 1.35 CNY per kWh and a selling price of 1.03 CNY per kWh, off-peak hours (07:00-10:00, 12:00-16:00, and 22:00-23:00) having a buying price of 0.90 CNY per kWh and a selling price of 0.67 CNY per kWh, and valley hours (23:00 to 07:00 of the next day) having a buying price of 0.40 CNY per kWh and a selling price of 0.27 CNY per kWh. The gas purchase price is fixed at 2.01 CNY per m³. The CO₂ emissions and mitigation costs for the gas turbine and the power grid are as shown in Table 5:

TABLE 5

| Equipment | Equipment parameter | Value |
|---|---|---|
| Gas turbine | CO₂ emissions | 0.16 kg/(kWh) |
| Grid | CO₂ emissions | 0.616 kg/(kWh) |
| | CO₂ mitigation costs | 0.11CNY/(kWh) |

Upper-level decision variables x include:

x={A_{PV},A_{SF},P_{CAESc},P_{CAESt},Vᵥ,Vₕ,ωᵥ,ωₕ} (22)

where P_{CAESc} is a rated power of a compressor; P_{CAESt} is an expansion power of an expander; Vᵥ is a volume of the air storage chamber; Vₕ is a volume of the thermal storage chamber; ωᵥ is an initial gas proportion in the air storage chamber; and ωₕ is an initial hot water proportion in the thermal storage chamber.

Establish an upper-level objective function max B_{bf}, with an objective of maximizing a net benefit brought by AA-CAES:

$$max {B}_{bf} = {C}_{noCAES} - {C}_{CAES} - {C}_{TCC} - {C}_{O \& M} \qquad ( 23 )$$

where C_{noCAES} is energy costs without AA-CAES configuration; C_{CAES} is energy costs with AA-CAES configuration, derived from lower-level scheduling; C_{TCC} is annualized investment costs, including costs for an energy production module and an energy storage module:

$${C}_{TCC} = ( {P}_{CAESc} {c}_{psc} + {P}_{CAESg} {c}_{psg} + {V}_{v} {c}_{ESa} + {V}_{h} {c}_{ESw} + {A}_{PV} {c}_{pv} + {A}_{SF} {c}_{SF} ) \frac{{i ( 1 + i )}^{T}}{{( 1 + i )}^{T} - 1} \qquad ( 24 )$$

where C_{psc} and C_{psg} represent investment costs per unit of rated compression power and rated expansion power, respectively; C_{ESa} is investment costs per unit of the air storage chamber; C_{SF} is investment costs per unit of the thermal storage chamber; C_{PV} is investment costs of each photovoltaic panel; C_{SF} is investment costs per unit of the mirror field; i is a discount rate; and T is a service life of system modules.

C_{O&M} is annualized operation and maintenance costs of the system:

$${C}_{O \& M} = {C}_{O \& ME} ( {P}_{CAESc} + {P}_{CAESg} ) + {C}_{O \& Mpv} {A}_{PV} {C}_{O \& MSF} {A}_{SF} \qquad ( 25 )$$

where C_{O&ME} is operation and maintenance costs per unit of compression turbine power; C_{O&MPV} is operation and maintenance costs per unit of the photovoltaic panels; and C_{O&MSF} is operation and maintenance costs per unit area of the mirror field.

Upper-level constraints are ground areas for photovoltaic panels and solar thermal collection:

$${A}_{PV} {S}_{PV} + {A}_{SF} \leq {S}_{MAX} \qquad ( 26 )$$

where S_{PV} is a ground area for a single photovoltaic panel; and S_{MAX} is a maximum total ground area.

Lower-level decision variables x include:

x={P_{CAESc,t},P_{CAESg,t},P_{GT,t},P_{b,t},P_{cold,t},P_{rb,t},M_{tesc,t},M_{tesx,t},M_{tescold,t}} (27)

where P_{CAESc,t} is an output of the compressor at time t; P_{CAESg,t} is an output of the expander at time t; P_{GT,t} is an output of the gas turbine at time t; P_{b,t} is an amount of electricity purchased from a power grid at time t; P_{rb,t} is an amount of electricity consumed by a heat pump at time t; P_{cold,t} is an amount of electricity used for cooling at time t; M_{tesc,t} is a mass of hot water stored into the thermal storage chamber at time t; M_{tesx,t} is a mass of hot water supplied from the thermal storage chamber at time t; and M_{tescold,t} is a mass of hot water used for absorption cooling at time t.

Step 3: Establish a lower-level objective function, with a scheduling objective of minimize energy supply costs and carbon mitigation costs after configuring AA-CAES:

$${C}_{CAES} = {D}_{spa} ( {P}_{spa} {C}_{e} + {P}_{spaGT} τ {C}_{gas} + {P}_{spab} {ψ}_{e} {C}_{{co}_{2}} + {P}_{spaGT} τ {ψ}_{g} {C}_{{co}_{2}} ) + {D}_{su} ( {P}_{sub} {C}_{e} + {P}_{suGT} τ {C}_{gas} + {P}_{sub} {ψ}_{e} {C}_{{co}_{2}} + {P}_{suGT} τ {ψ}_{g} {C}_{{co}_{2}} ) + {D}_{w} ( {P}_{wb} {C}_{e} + {P}_{wGT} τ {C}_{gas} + {P}_{wb} {ψ}_{e} {C}_{{co}_{2}} + {P}_{wGT} τ {ψ}_{g} {C}_{{co}_{2}} ) \qquad ( 28 )$$

where Dₛₚₐ, Dₛᵤ, D_{w} represent the number of days in transitional seasons, summer, and winter, respectively, during one year; P_{spab}, P_{sub}, P_{wb} represent amounts of purchased electricity on typical days in transitional seasons, summer, and winter, respectively; Cₑ is an electricity price, using time-of-use pricing; P_{spaGT}, P_{suGT}, P_{wGT} represent outputs of a gas turbine on typical days in transitional seasons, summer, and winter, respectively; τ is a correlation coefficient between the output of the gas turbine and natural gas; C_{gas} is purchase costs of natural gas per unit; ψₑ is a conversion coefficient of CO₂ per unit of grid electricity; ψₑ is a conversion coefficient of CO₂ per unit of natural gas combustion; and C_{co}_{₂} is mitigation costs per unit of CO₂.

Lower-level constraints include:

### (1) Electrical Power Balance Constraint:

P_{b,t}+P_{GT,t}+P_{WT,t}+P_{PV,t}+P_{t,t}=P_{L,t}+P_{c,t}+P_{bc,t} (29)

where P_{WT,t} is a wind power output at time t; P_{bc,t} is an amount of electricity used for electric cooling; and P_{L,t} is an amount of electricity for electric load.

### (2) Thermal Power Balance Constraint:

H_{gl,t}+M_{tesg,t}σₕ+P_{SF,t}+M_{c,2}σₕ+P_{rb}σₑᵣ=H_{L,t}+M_{tesc,t}σₕ+M_{g,2}σₕ+M_{tescold,t}σₕ (30)

where H_{L,t} is thermal load at time t; M_{c,2} and M_{g,2} represent a mass of water for compression/expansion and a mass of water for heat generation, respectively; and σₕ is a conversion coefficient between a hot water mass and heat.

### (3) Cold Power Balance Constraint:

P_{bc,t}σ_{ec}+M_{tescold,t}σₕσ_{hc}+P_{t,cold,t}=Cold_{L,t} (31)

where σ_{ec} is electrical cooling efficiency; σ_{hc} is absorption cooling efficiency; P_{t,cold,t} is a cooling capacity of the expander at time t; and Cold_{L,t} is cooling load at time t.

### (4) AA-CAES Module Constraints:

$$\{ \begin{matrix}0 \leq {u}_{c , t} + {u}_{t , t} \leq 1 \\ 0 \leq {P}_{c , t} \leq {u}_{c , t} {P}_{CAESc} \\ 0 \leq {P}_{t , t} \leq {u}_{t , t} {P}_{CAESt} \\ {V}_{v} {ρ}_{min} \leq {M}_{a , c} {u}_{c , t} - {M}_{a , t} {u}_{t , t} + {M}_{air , t} \leq {V}_{v} {ρ}_{max}\end{matrix} \qquad ( 32 )$$

where the first equation represents condition constraints for a compression turbine, and u_{c,t} and u_{g,t} represent conditions of the compression turbine at time t, which are binary variables; the second equation represents constraints on a compression power; the third equation represents constraints on an expansion power; and the fourth equation represents constraints on the air storage chamber, where M_{a,c} and M_{a,t} represent air masses during compression/expansion, and ρₘᵢₙ/ρₘₐₓ represent an air density corresponding to a minimum/maximum pressure set for the air storage chamber.

### (5) CHP Constraints:

$$\{ \begin{matrix}{μ}_{GT , t} {P}_{GT , min} \leq {P}_{GT , t} \leq {μ}_{GT , t} {P}_{GT , max} \\ 0 \leq {H}_{gl , t} \leq {H}_{gl , max}\end{matrix} \qquad ( 33 )$$

where the first equation represents an output constraint on the gas turbine, μ_{GT,t} is a start-stop coefficient of the gas turbine and is a binary variable, and P_{GT,max} and P_{GT,min} represent a maximum output value and a minimum output value of the gas turbine; and the second equation represents an output constraint on the waste heat recovery boiler, where H_{gl,max} is a maximum output value of the waste heat recovery boiler.

### (6) Thermal Storage Chamber Constraints:

$$\{ \begin{matrix}0 \leq {μ}_{hc , t} + {μ}_{hx , t} \leq 0 \\ {V}_{min} {ρ}_{w} \leq {M}_{tesc , t} {μ}_{hc , t} - {M}_{tesx , t} {μ}_{hx , t} + {M}_{tes , t} \leq {V}_{h} {ρ}_{w}\end{matrix} \qquad ( 34 )$$

where in the first equation, μ_{hc,t} and μ_{hx,t} represent condition constraints for thermal storage/supply of the thermal storage chamber; and in the second equation, Vₘᵢₙ is a minimum thermal storage value set for the thermal storage chamber, ρ_{w} is a density at a set temperature of the thermal storage chamber, and M_{tes,t} is a mass of stored hot water in the thermal storage chamber at time t.

### (7) Heat Pump and Electric Cooling Constraints:

$$\{ \begin{matrix}0 \leq {P}_{rb} * {σ}_{er} \leq {Q}_{rb} \\ 0 \leq {P}_{bc} * {σ}_{ec} \leq {Cold}_{bc}\end{matrix} \qquad ( 35 )$$

where Q_{rb} is a maximum output thermal power of the heat pump, and Cold_{bc} is a maximum output power for electric cooling.

### (8) Electricity Purchase Constraints:

−P_{s,max}≤P_{b,t}≤P_{b,max} (36)

where P_{b,max} represents a maximum amount of purchased electricity, and P_{s,max} represents a maximum amount of sold electricity.

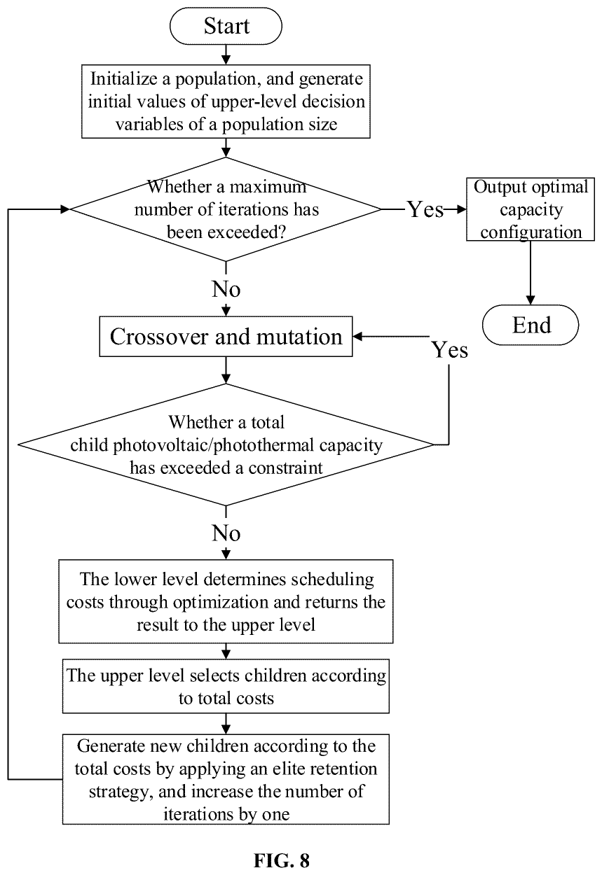

Step 4: Perform crossover and mutation on decision variables by using a genetic algorithm (NSGA-II) at the upper level, with an objective of minimizing total costs, select new parent capacity values based on the total costs by applying an elite retention strategy, and pass down results to the lower level. At the lower level, a Gurobi solver is employed to schedule a lower-level model after the results from the upper level are received; and scheduling results are then returned to the upper level to assist in capacity decisions, achieving dual-level planning. The algorithm flowchart is shown in FIG. 8. Simulation was conducted in MATLAB software to obtain investment costs, scheduling costs, and scheduling costs without the AA-CAES system, as shown in Table 6:

| Parameter | Value | Parameter | Value |
|---|---|---|---|
| Ground area of photovoltaic panels/m² | 1100 | Investment costs of energy storage system/ | 2863890 |
| | | CNY | |
| Ground area of mirror field/m² | 896 | Scheduling costs with energy storage/CNY | 3348047 |
| Rated compression power/kW | 690 | Scheduling costs without AA-CAES | 4374189 |
| | | configuration/CNY | |
| Rated expansion power/kW | 321 | Benefit brought by AA-CAES configuration/ | 1026142 |
| | | CNY | |
| Rated volume of air storage chamber/m³ | 427 | Payback period/years | 3 |
| Initial volume ratio of air storage chamber | 0.7 | | |
| Rated volume of thermal storage chamber/m³ | 125 | | |
| Initial volume ratio of thermal storage chamber | 0.3 | | |

### Table 6

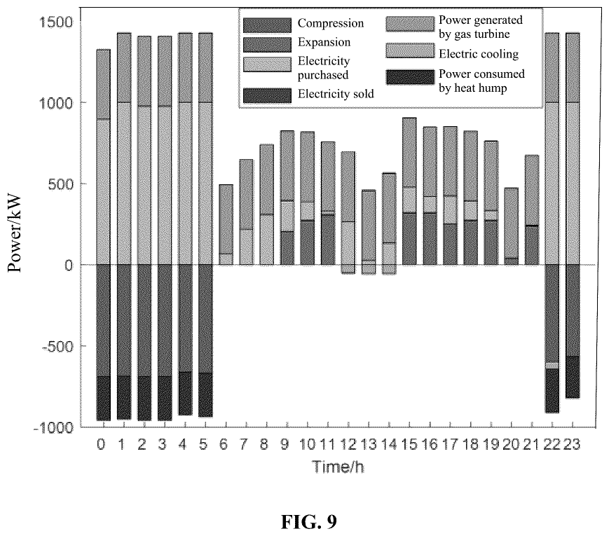

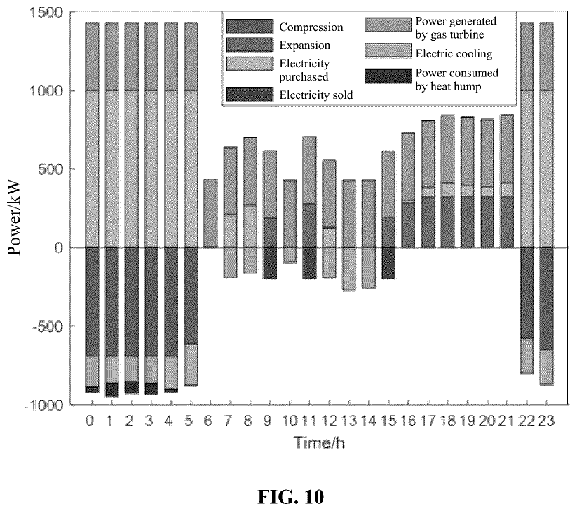

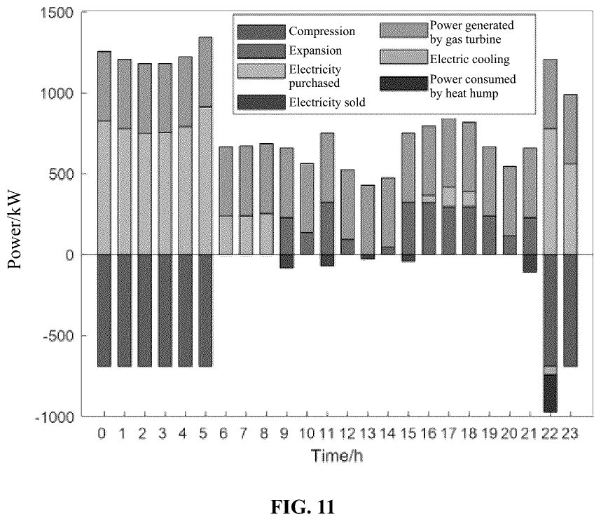

From the simulation results, it can be observed that the scheduling costs of the system are reduced after the configuration of AA-CAES. Although the initial investment costs of AA-CAES are relatively high, AA-CAES has a long operational lifespan, and the investment costs can be recovered in approximately 3 years. After the system is configured with AA-CAES, the scheduling of various output modules in different seasons is illustrated in FIG. 9 to FIG. 17. FIG. 9, FIG. 10, and FIG. 11 depict the energy scheduling during winter, summer, and transitional seasons, respectively. It can be seen from the figures that the gas turbine, as high-quality electricity output equipment, generally operates at high load. The compression phase of the AA-CAES energy storage equipment typically occurs during valley electricity hours, which is also the period when a substantial amount of electricity is purchased from the power grid, indicating an effective valley-filling capability of AA-CAES. The expansion phase occurs during peak electricity hours, which usually is also the period when electricity is sold back to the power grid, indicating an effective peak-shaving capability of AA-CAES.

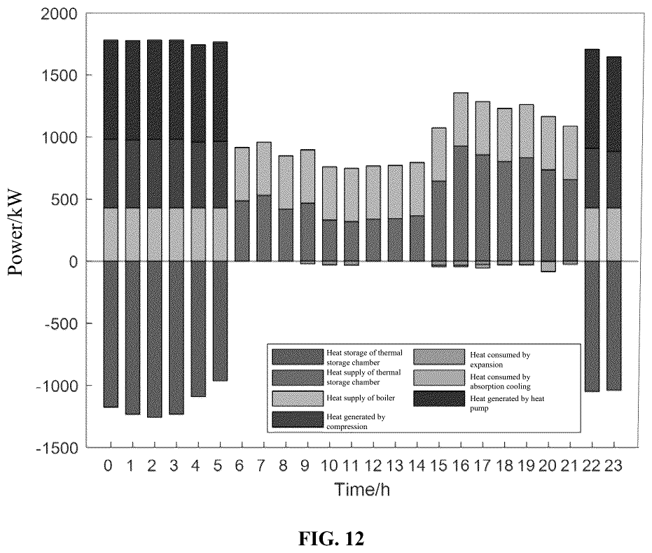

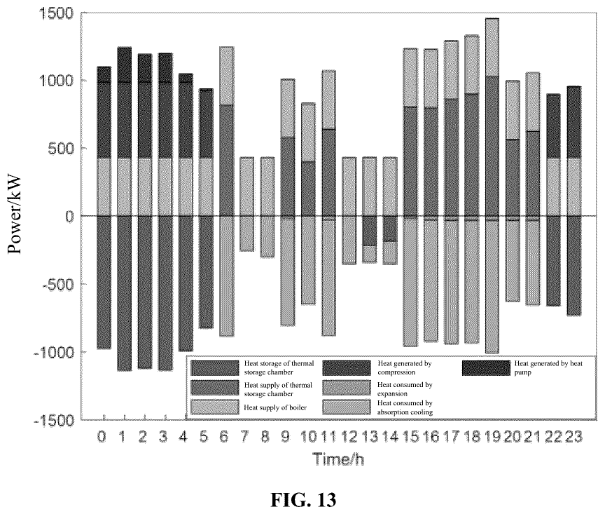

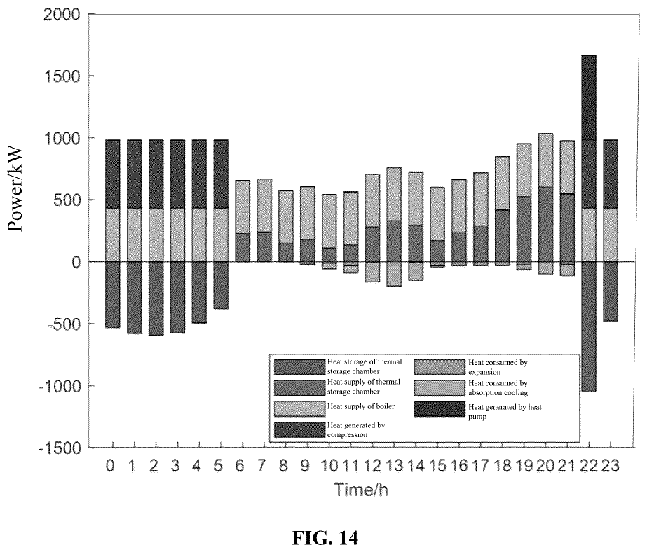

FIG. 12, FIG. 13, and FIG. 14 depict the thermal energy scheduling during winter, summer, and transitional seasons, respectively. From the figures, it can be observed that due to the high-load operation of the gas turbine, the heat generation from the waste heat boiler is also high. Heat generation from the electric pump and compression occurs during valley electricity hours. Although the heat demand during these hours is relatively low, excess heat can be stored in the thermal storage chamber and released during peak heat demand, thus avoiding the purchase of expensive electricity for heating, which would increase scheduling costs.

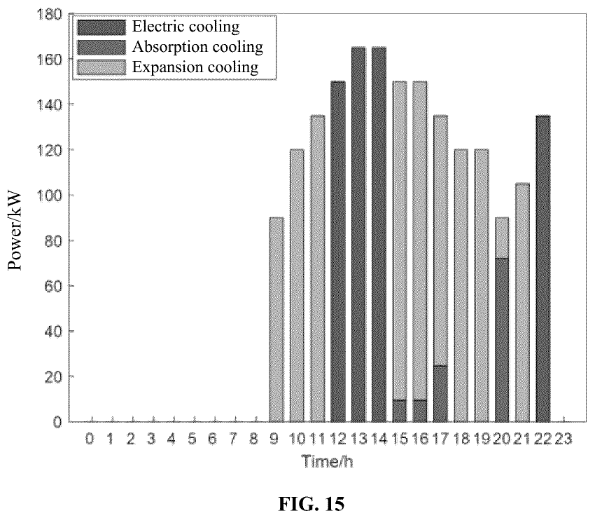

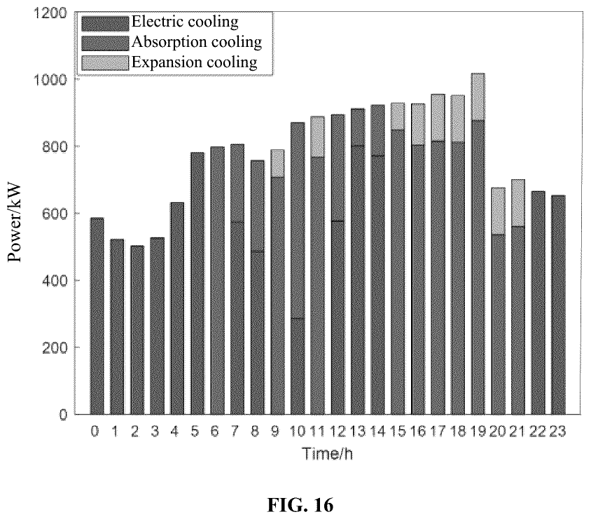

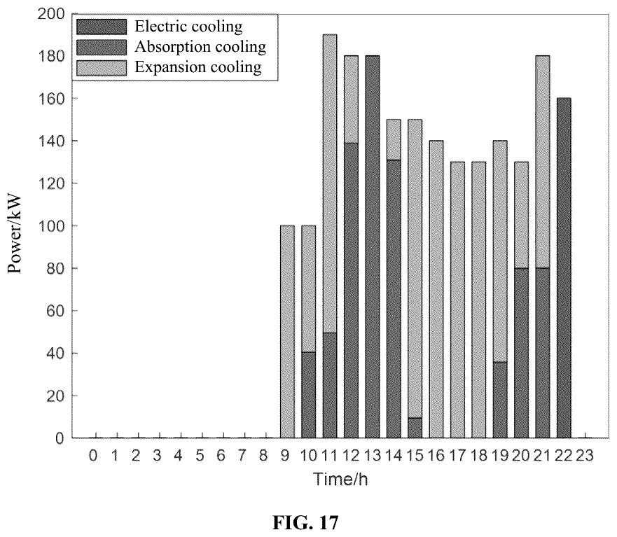

FIG. 15, FIG. 16, and FIG. 17 illustrate the cooling energy scheduling during winter, summer, and transitional seasons, respectively. It can be observed from the figures that in winter, due to higher heat demand, electric cooling and expansion cooling are mainly used. During the transitional seasons, with higher electricity demand, absorption cooling and electric cooling are the main sources of cooling. In summer, expansion cooling primarily occurs during peak electricity hours, while absorption cooling and electric cooling are used in combination to meet cooling demand. These figures show that AA-CAES can provide stable cooling through expansion throughout each season. The inherent ability of AA-CAES to provide combined cooling, heating, and power aligns well with the CCHP micro integrated energy system, enhancing the flexibility of energy supply within CCHP micro grids.

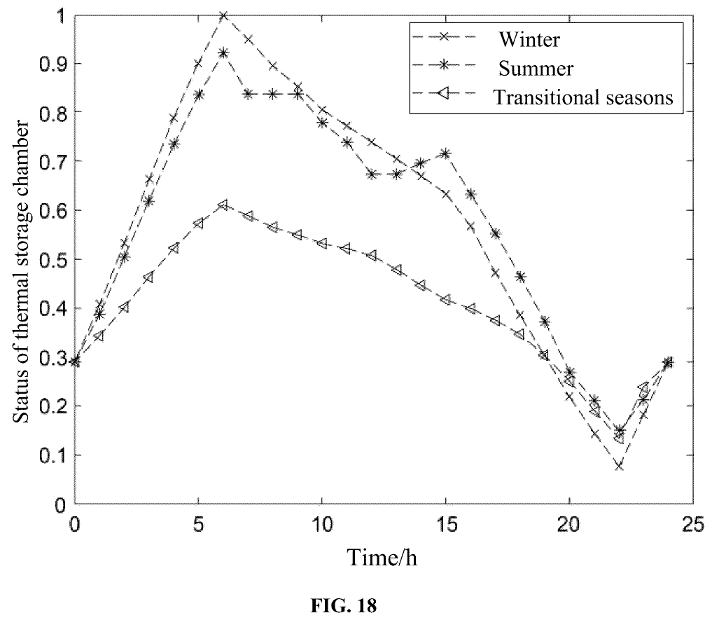

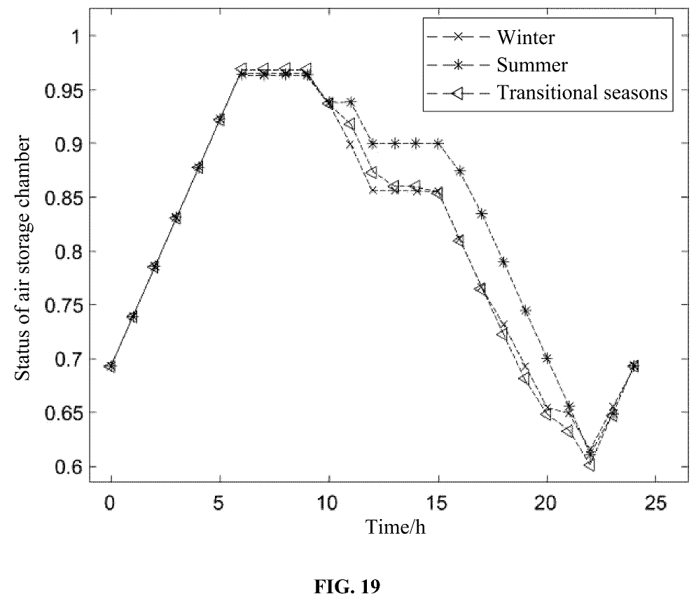

FIG. 18 shows the hot water storage status in the thermal storage chamber. The optimal initial thermal storage ratio for winter, summer, and transitional seasons is 0.3, and after one day, the thermal storage chamber can restore its initial hot water volume. FIG. 19 shows the gas storage status in the air storage chamber. The optimal initial gas ratio for the air storage chamber is 0.7. During periods of low electricity prices when a substantial amount of electricity is purchased from the power grid, a significant amount of electricity is stored in AA-CAES, leading to rapid growth in the air storage volume of the air storage chamber during this time. After one day, the air storage chamber can restore its initial gas volume. The system has optimized the initial ratios for gas storage and thermal storage in AA-CAES, demonstrating that the initial ratios are values that affect the capacity planning of the system.

1. A capacity configuration method for photovoltaic/photothermal/Advanced Adiabatic Compressed Air Energy Storage (AA-CAES) of combined cooling, heating and power (CCHP), comprising the following steps:
step 1: establishing a CCHP micro integrated energy system model containing AA-CAES, which comprises inputs from renewable energy sources of wind power, photovoltaic power, and solar thermal collection, a combined heat and power (CHP) unit with a gas generator and a waste heat recovery boiler, refrigeration equipment for absorption cooling and electric cooling, and an energy storage device of AA-CAES, wherein it is assumed that in the system model, air behaves as an ideal gas, following an ideal gas state equation, an air storage chamber has a temperature approximately equal to ambient temperature, a thermal storage chamber has a temperature approximately equal to a rated temperature, and water serves as a heat transfer medium;
step 2: establishing an upper-level objective function max B_{bf}, with an objective of maximizing a net benefit brought by AA-CAES:
max B_{bf}=C_{noCAES}−C_{CAES}−C_{TCC}−C_{O&M}
wherein C_{noCAES} is energy costs without AA-CAES configuration; C_{CAES} is energy costs with AA-CAES configuration, derived from lower-level scheduling; C_{TCC} is annualized investment costs; and C_{O&M} is annualized operation and maintenance costs of a system;
upper-level decision variables x comprise:
x={A_{PV},A_{SF},P_{CAESc},P_{CAESt},Vᵥ,Vₕ,ωᵥ,ωₕ}
wherein A_{PV} is the number of photovoltaic panels; A_{SF} is a ground area of a mirror field; P_{CAESc} is a rated power of a compressor; P_{CAESt} is an expansion power of an expander; Vᵥ is a volume of the air storage chamber; Vₕ is a volume of the thermal storage chamber; ωᵥ is an initial gas proportion in the air storage chamber; and ωₕ is an initial hot water proportion in the thermal storage chamber;
upper-level constraints are ground areas for photovoltaic panels and solar thermal collection:
A_{PV}S_{PV}+A_{SF}≤S_{MAX}
wherein S_{PV} is a ground area for a single photovoltaic panel; and S_{MAX} is a maximum total ground area;
step 3: establishing a lower-level objective function, with a scheduling objective of minimizing energy supply costs and carbon mitigation costs after configuring AA-CAES:
$${C}_{CAES} = {D}_{spa} ( {P}_{spa} {C}_{e} + {P}_{spaGT} τ {C}_{gas} + {P}_{spab} {ψ}_{e} {C}_{{co}_{2}} + {P}_{spaGT} τ {ψ}_{g} {C}_{{co}_{2}} ) + {D}_{su} ( {P}_{sub} {C}_{e} + {P}_{suGT} τ {C}_{gas} + {P}_{sub} {ψ}_{e} {C}_{{co}_{2}} + {P}_{suGT} τ {ψ}_{g} {C}_{{co}_{2}} ) + {D}_{w} ( {P}_{wb} {C}_{e} + {P}_{wGT} τ {C}_{gas} + {P}_{wb} {ψ}_{e} {C}_{{co}_{2}} + {P}_{wGT} τ {ψ}_{g} {C}_{{co}_{2}} )$$
wherein Dₛₚₐ, Dₛᵤ, D_{w} represent the number of days in transitional seasons, summer, and winter, respectively, during one year; P_{spab}, P_{sub}, P_{wb} represent amounts of purchased electricity on typical days in transitional seasons, summer, and winter, respectively; Cₑ is an electricity price, using time-of-use pricing; P_{spaGT}, P_{suGT}, P_{wGT} represent outputs of a gas turbine on typical days in transitional seasons, summer, and winter, respectively; τ is a correlation coefficient between the output of the gas turbine and natural gas; C_{gas} is purchase costs of natural gas per unit; ψₑ is a conversion coefficient of CO₂ per unit of grid electricity; ψₑ is a conversion coefficient of CO₂ per unit of natural gas combustion; and C_{co}_{₂} is mitigation costs per unit of CO₂;
lower-level decision variables x comprise:
x={P_{CAESc,t},P_{CAESg,t},P_{GT,t},P_{b,t},P_{cold,t},P_{rb,t},M_{tesc,t},M_{tesx,t},M_{tescold,t}}
wherein P_{CAESc,t} is an output of the compressor at time t; P_{CAESg,t} is an output of the expander at time t; P_{GT,t} is an output of the gas turbine at time t; P_{b,t} is an amount of electricity purchased from a power grid at time t; P_{rb,t} is an amount of electricity consumed by a heat pump at time t; P_{cold,t} is an amount of electricity used for cooling at time t; M_{tesc,t} is a mass of hot water stored into the thermal storage chamber at time t; M_{tesx,t} is a mass of hot water supplied from the thermal storage chamber at time t; and M_{tescold,t} is a mass of hot water used for absorption cooling at time t;
lower-level constraints comprise an electric power balance constraint, a thermal power balance constraint, a cold power balance constraint, AA-CAES module constraints, CHP constraints, thermal storage chamber constraints, heat pump and electric cooling constraints, and electricity purchase constraints; and
step 4: performing crossover and mutation on decision variables by using a genetic algorithm (NSGA-II) at the upper level, with an objective of minimizing total costs, selecting new parent capacity values based on the total costs by applying an elite retention strategy, and passing down results to the lower level, wherein at the lower level, a Gurobi solver is employed to schedule a lower-level model after the results from the upper level are received, and scheduling results are then returned to the upper level to assist in capacity decisions, achieving dual-level planning.

2. The capacity configuration method for photovoltaic/photothermal/AA-CAES of CCHP according to claim 1, wherein the lower-level constraints specifically comprise:
(1) electrical power balance constraint:
P_{b,t}+P_{GT,t}+P_{WT,t}+P_{PV,t}+P_{t,t}=P_{L,t}+P_{c,t}+P_{bc,t}
wherein P_{WT,t} is a wind power output at time t; P_{bc,t} is an amount of electricity used for electric cooling; and P_{L,t} is an amount of electricity for electric load;
(2) thermal power balance constraint:
H_{gl,t}+M_{tesg,t}σₕ+P_{SF,t}+M_{c,2}σₕ+P_{rb}σₑᵣ=H_{L,t}+M_{tesc,t}σₕ+M_{g,2}σₕ+M_{tescold,t}σₕ
wherein H_{L,t} is thermal load at time t; M_{c,2} and M_{g,2} represent a mass of water for compression/expansion and a mass of water for heat generation, respectively; and σₕ is a conversion coefficient between a hot water mass and heat;
(3) cold power balance constraint:
P_{bc,t}σ_{ec}+M_{tescold,t}σₕσ_{hc}+P_{t,cold,t}=Cold_{L,t}
wherein σ_{ec} is electric cooling efficiency; σ_{hc} is absorption cooling efficiency; P_{t,cold,t} is a cooling capacity of the expander at time t; and Cold_{L,t} is cooling load at time t;
(4) AA-CAES module constraints:
$$\{ \begin{matrix}0 \leq {u}_{c , t} + {u}_{t , t} \leq 1 \\ 0 \leq {P}_{c , t} \leq {u}_{c , t} {P}_{CAESc} \\ 0 \leq {P}_{t , t} \leq {u}_{t , t} {P}_{CAESt} \\ {V}_{v} {ρ}_{min} \leq {M}_{a , c} {u}_{c , t} - {M}_{a , t} {u}_{t , t} + {M}_{air , t} \leq {V}_{v} {ρ}_{max}\end{matrix}$$
wherein the first equation represents condition constraints for a compression turbine, and u_{c,t} and u_{g,t} represent conditions of the compression turbine at time t, which are binary variables; the second equation represents constraints on a compression power; the third equation represents constraints on an expansion power; and the fourth equation represents constraints on the air storage chamber, wherein M_{a,c} and M_{a,t} represent air masses during compression/expansion, and ρₘᵢₙ/ρₘₐₓ represent an air density corresponding to a minimum/maximum pressure set for the air storage chamber;
(5) CHP constraints:
$$\{ \begin{matrix}{μ}_{GT , t} {P}_{GT , min} \leq {P}_{GT , t} \leq {μ}_{GT , t} {P}_{GT , min} \\ 0 \leq {H}_{gl , t} \leq {H}_{gl , max}\end{matrix}$$
wherein the first equation represents an output constraint on the gas turbine, μ_{GT,t} is a start-stop coefficient of the gas turbine and is a binary variable, and P_{GT,max} and P_{GT,min} represent a maximum output value and a minimum output value of the gas turbine; and the second equation represents an output constraint on the waste heat recovery boiler, wherein H_{gl,max} is a maximum output value of the waste heat recovery boiler;
(6) thermal storage chamber constraints:
$$\{ \begin{matrix}0 \leq {μ}_{hc , t} + {μ}_{hx , t} \leq 0 \\ {V}_{min} {ρ}_{w} \leq {M}_{tesc , t} {μ}_{hc , t} - {M}_{tesx , t} {μ}_{hx , t} + {M}_{tes , t} \leq {V}_{h} {ρ}_{w}\end{matrix}$$
wherein in the first equation, μ_{hc,t} and μ_{hx,t} represent condition constraints for thermal storage/supply of the thermal storage chamber; and in the second equation, Vₘᵢₙ is a minimum thermal storage value set for the thermal storage chamber, ρ_{w} is a density at a set temperature of the thermal storage chamber, and M_{tes,t} is a mass of stored hot water in the thermal storage chamber at time t;
(7) heat pump and electric cooling constraints:
$$\{ \begin{matrix}0 \leq {P}_{rb} * {σ}_{er} \leq {Q}_{rb} \\ 0 \leq {P}_{bc} * {σ}_{ec} \leq {Cold}_{bc}\end{matrix}$$
wherein Q_{rb} is a maximum output thermal power of the heat pump, and Cold_{bc} is a maximum output power for electric cooling; and
(8) electricity purchase constraints:
−P_{s,max}≤P_{b,t}≤P_{b,max}
wherein P_{b,max} represents a maximum amount of purchased electricity, and P_{s,max} represents a maximum amount of sold electricity.

3. The capacity configuration method for photovoltaic/photothermal/AA-CAES of CCHP according to claim 1, wherein an AA-CAES model comprises a compression phase, a compression heat transfer phase, a compression heat storage phase, an expansion heat transfer phase, an expansion heat release phase, and an expansion phase; and an output power of an i-th stage expander in the expansion phase is:
P_{t,i}(t)=ηₜmₐcₚTᵢ[1−βₜ^{-(γ-1)/(γN)}]
wherein ηₜ is expansion efficiency, βₜ is an expansion ratio of the expander, and a corresponding air mass is derived from the expansion power;
an air outlet temperature of the i-th stage expander in the expansion phase is:
T_{t,i,out}=Tᵢ{1−ηₜ[1−βₜ^{-(γ-1)/(γN)}]}
a cooling capacity output of the expansion phase is:
P_{t,cold}=mₐcₚ(T₀−T_{t,N,out})
wherein T₀ is the ambient temperature, and T_{t,N,out} is an outlet temperature of a last-stage expander;
a photovoltaic output power model is:
Pₚᵥ=P_{STC}I[1+k(Tₚᵥ−Tᵣ)]/I_{STC}A_{PV}
wherein P_{STC} is a rated power of the photovoltaic panel under standard test conditions; I is light intensity; k is a power temperature coefficient; A_{PV} is the number of photovoltaic panels; and Tₚᵥ is a temperature of a photovoltaic power generation component:
Tₚᵥ=T₀+0.03I
a solar thermal collection model is:
P_{SF}=IA_{SF}I_{L}I_{T}η_{OPT,R}η_{END}η_{CIN} [symbol]
wherein A_{SF} is a ground area of a mirror field; I_{L} and I_{T} are longitudinal and transverse components of an incidence angle adjustment rate; η_{OPT,R} is reference optical efficiency; η_{END} is terminal loss optical efficiency; η_{CIN} is a cleanliness coefficient of a mirror and a glass tube; and [symbol] is a heat transfer coefficient of a solar cooling heat exchanger; and
CHP generation comprises the gas turbine unit and the waste heat recovery boiler, and a relationship between the output of the gas turbine and recovered heat is as follows:
P_{CHP}^{e}(t)=η_{CHP}^{e}G_{CHP}(t)LHV_{gas}/3.6
P_{CHP}^{h}(t)=η_{CHP}^{h}G_{CHP}(t)LHV_{gas}/3.6
wherein η_{CHP}^{e} and η_{CHP}^{e} are electricity generation efficiency and heat generation efficiency of the unit; P_{CHP}^{e} and P_{CHP}^{h} are electric and thermal outputs of the unit, in kW; G_{CHP} is gas consumption at time t of the CHP unit, in kg/h; LHV_{gas} is a lower heating value of natural gas.

4. The capacity configuration method for photovoltaic/photothermal/AA-CAES of CCHP according to claim 1, wherein the annualized investment costs C_{TCC} of the system comprise costs for an energy production module and an energy storage module:
$${C}_{TCC} = ( {P}_{CAESc} {c}_{psc} + {P}_{CAESg} {c}_{psg} + {V}_{v} {c}_{ESa} + {V}_{h} {c}_{ESw} + {A}_{PV} {c}_{pv} + {A}_{SF} {c}_{SF} ) \frac{{i ( 1 + i )}^{T}}{{( 1 + i )}^{T} - 1}$$
wherein C_{psc} and C_{psg} represent investment costs per unit of rated compression power and rated expansion power, respectively; C_{ESa} is investment costs per unit of the air storage chamber; C_{SF} is investment costs per unit of the thermal storage chamber; C_{PV} is investment costs of each photovoltaic panel; C_{SF} is investment costs per unit of the mirror field; i is a discount rate; and T is a service life of system modules;
the annualized operation and maintenance costs C_{O&M} of the system are as follows:
C_{O&M}=C_{O&ME}(P_{CAESc}+P_{CAESg})+C_{O&Mpv}A_{PV}C_{O&MSF}A_{SF}
wherein C_{O&ME} is operation and maintenance costs per unit of compression turbine power; C_{O&MPV} is operation and maintenance costs per unit of the photovoltaic panels; and C_{O&MSF} is operation and maintenance costs per unit area of the mirror field.
